(19) United States
(12) Patent Application Publication
(10) Pub. No.: US 2026/0084905 A1
(43) Pub. Date: Mar. 26, 2026

(54) ARM FOR A CONVEYOR SYSTEM

(71) Applicant: Intelligrated Headquarters, LLC, Mason, OH (US)

(72) Inventors: Gregory Matthew POLLITT, Loveland, OH (US); Ashley Elizabeth ADAMS, Oakwood, GA (US); Chase GRIFFITH, Cincinnati, OH (US); Uzair RIAZ, Cincinnati, OH (US); Dongjie CHEN, Meridian, ID (US); Harsha Sanjeewa BULATHSINGHALAGE, Miamisburg, OH (US)

(21) Appl. No.: 18/890,936

(22) Filed: Sep. 20, 2024

(51) Int. Cl. B65G 47/91; B65G 43/02

(52) U.S. Cl. CPC B65G 47/91; B65G 43/02

(57) ABSTRACT

An arm configured to be coupled to a side rail of a conveyor system is disclosed. The arm comprising an end effector configured to pick and place one or more objects to or from the conveyor system. Further, the arm is configured to receive a jam signal from a jam detector of the conveyor system. Further, the jam detector is configured to detect a jam of the one or more objects on the conveyor system and generate the jam signal corresponding to the detection of the jam. Thereafter, the arm is configured to pick the one or more objects to unjam the one or more objects on the conveyor system in response to receiving the jam signal from the jam detector.

### TECHNOLOGICAL FIELD

Example embodiments of the present disclosure relate generally to a conveyor system, and more particularly, to an arm to unjam objects on the conveyor system and a method thereof.

### BACKGROUND

Conveyor systems are widely used in various industries to transport packages of different shapes and sizes. The conveyor systems are used for maintaining efficient workflows. However, such conveyor systems suffer from an issue i.e., occurrence of package jams. The package jams can be caused by a variety of hardware or software communication problems. The package jams generally disrupt the workflow, leading to system downtime and necessitating immediate intervention from workers to clear the blockage. Conventionally, most conveyor systems rely on jam detection sensors or manual observation to identify these package jams and rely on manual intervention to clear the package jams. Manually clearing package jams by an operator may increase downtime of the conveyor system and may pose safety issues for the operator. As a result, these inefficiencies often lead to prolonged downtimes, affecting overall productivity, and operational efficiency.

The inventors identified numerous deficiencies and problems in in existing technologies and processes, which are the subjects of embodiments described herein. Through applied effort, ingenuity, and innovation, many of these deficiencies and problems have been solved by developing solutions that are included in embodiments of the present disclosure, many examples of which are described in detail herein.

### BRIEF SUMMARY

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, an arm configured to be coupled to a side rail of a conveyor system is disclosed. The arm comprising an end effector configured to pick and place one or more objects to or from the conveyor system. Further, the arm is configured to receive a jam signal from a jam detector of the conveyor system. Further, the jam detector is configured to detect a jam of the one or more objects on the conveyor system and generate the jam signal corresponding to the detection of the jam. Thereafter, the arm is configured to pick the one or more objects to unjam the one or more objects on the conveyor system in response to receiving the jam signal from the jam detector.

In some embodiments, the arm comprises a proximal portion and a distal portion. Further, the distal portion is moveable relative to the proximal portion. In some embodiments, the proximal portion defines a rotational axis, and further, the proximal portion is configured to rotate on the rotational axis. In some embodiments, the proximal portion is configured to extend or retract along a vertical direction and the distal portion is configured to extend or retract along a horizontal direction.

In some embodiments, the distal portion defines a first end and a second end, and further the first end of the distal portion is coupled to the proximal portion in a right angle such that the distal portion is configured to be positioned over the conveyor system. In some embodiments, the end effector is coupled to the second end of the distal portion for picking and placing the one or more objects on the conveyor system.

In some embodiments, the arm is moveably coupled to the side rail of the conveyor system, and further the arm is configured to move along the side rail from an initial position to one or more locations to pick the one or more objects from the one or more locations and place the one or more objects to another location.

In some embodiments, the arm is configured to return back to the initial position after placing the one or more objects at the another location. In some embodiments, the initial position corresponds to at least a start section position, an end section position, or a middle section position of the conveyor system.

In some embodiments, the arm is rigidly coupled to the side rail of the conveyor system. In some embodiments, the end effector comprises a gripping arm or a vacuum suction grip unit.

In another example embodiment, a method is disclosed. The method comprising receiving, via an arm configured to be coupled to a side rail of a conveyor system, a jam signal from a jam detector of the conveyor system, a jam signal from a jam detector of the conveyor system, wherein the jam detector is configured to detect a jam of one or more objects on the conveyor system and generate the jam signal corresponding to the detection of the jam; and picking, via the arm, the one or more objects to unjam the one or more objects on the conveyor system in response to receiving the jam signal from the jam detector, wherein the arm comprises an end effector configured to pick and place the one or more objects to or from the conveyor system.

The above summary is provided merely for purposes of summarizing some exemplary embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained within the following detailed description and its accompanying drawings.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIGS. 1A-1B illustrate isometric views of a conveyor system having a side rail coupled with an arm in accordance with an example embodiment of the present disclosure;

FIG. 2A illustrates a side view of the arm in accordance with an example embodiment of the present disclosure;

FIG. 2B illustrates an isometric view of the arm in accordance with an example embodiment of the present disclosure;

FIG. 2C illustrates a top view of the arm in accordance with an example embodiment of the present disclosure;

FIG. 3 illustrates an isometric view of the conveyor system comprising the arm in accordance with an example embodiment of the present disclosure;

FIG. 4 illustrates operations of the arm while unjamming one or more objects on the conveyor system in accordance with an example embodiment of the present disclosure;

FIG. 5 illustrates an isometric view of the conveyor system comprising a plurality of arms, such as an arm and an another arm in accordance with another example embodiment of the present disclosure; and

FIG. 6 illustrates an isometric view of the conveyor system comprising the arm having an end effector in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of an arm configured to be coupled to a side rail of a conveyor system is disclosed. Embodiments may comprise an end effector that may be configured to pick and place one or more objects to or from the conveyor system. Embodiments may be configured to receive a jam signal from a jam detector of the conveyor system. The jam detector may be configured to detect a jam of the one or more objects on the conveyor system and generate the jam signal corresponding to the detection of the jam. Embodiments may be configured to pick the one or more objects to unjam the one or more objects on the conveyor system in response to receiving the jam signal from the jam detector.

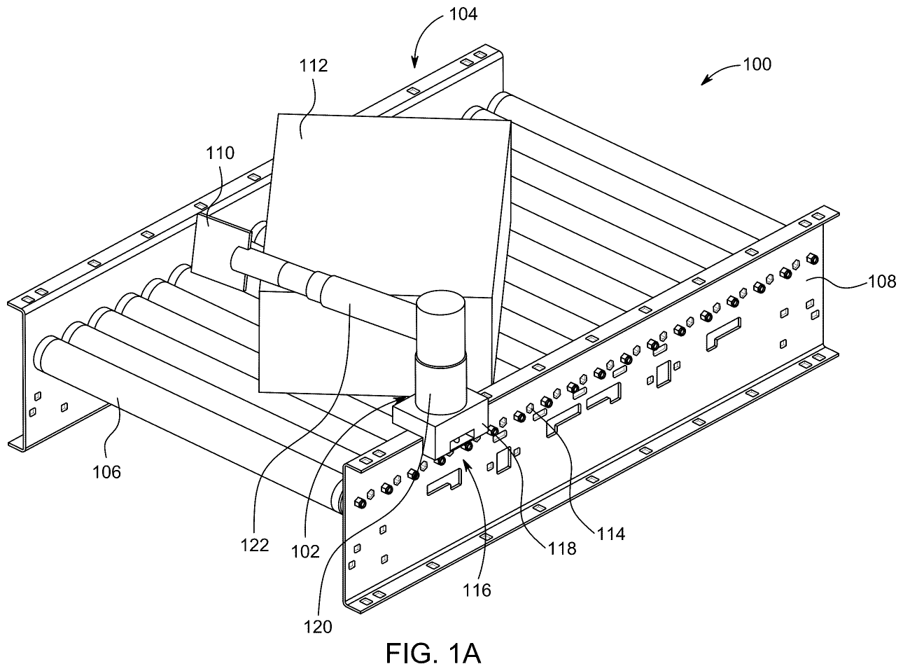

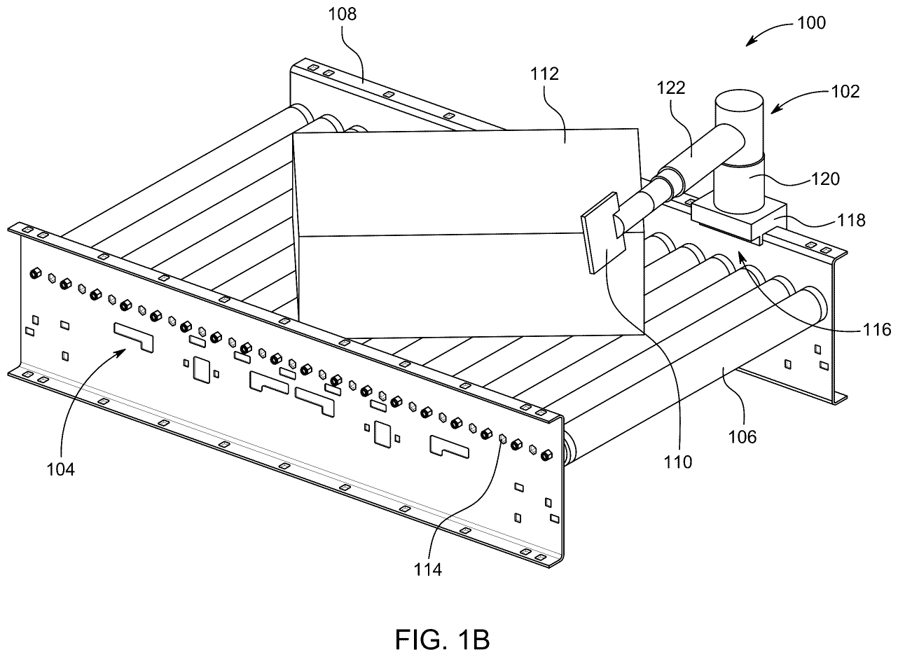

FIGS. 1A-1B illustrate isometric views of a conveyor system 100 having a side rail 108 coupled with an arm 102, in accordance with an example embodiment of the present disclosure.

In some embodiments, the conveyor system 100 may comprise a pair of side rails 104 and a plurality of idler rollers 106. In some embodiments, the arm 102 may be configured to couple with the side rail 108 of the pair of side rails 104 of the conveyor system 100. In some embodiments, the arm 102 may comprise an end effector 110 that may be configured to pick and place one or more objects 112 to and from the conveyor system 100. In some embodiments, the conveyor system 100 may be configured to translate one or more objects 112 from one location to another location. Further, the conveyor system 100 may be installed within a facility. Further, the facility may comprise at least one of a warehouse, a factory, a retail store, etc.

In some embodiments, the one or more objects 112 may comprise but not limited to one or more cartons, one or more boxes, etc. In some embodiments, the conveyor system 100 may be configured to translate the one or more objects 112 in one or more directions. In some embodiments, the conveyor system 100 may comprise at least one of a belt conveyor system, roller bed conveyor system, slider bed conveyor system, etc. In some embodiments, the conveyor system 100 may comprise the plurality of idler rollers 106. Further, the plurality of idler rollers 106 may be configured to translate the one or more objects 112 over the conveyor system 100 from one location to another location. Further, each idler roller of the plurality of idler rollers 106 may define a rotational axis. Further, each idler roller of the plurality of idler rollers 106 may be configured to rotate on the rotational axis to translate the one or more objects 112 from one location to another location.

In some embodiments, the plurality of idler rollers 106 may be self-powered and/or requires at least one actuation media for translating the one or more objects 112 from one end of the conveyor system 100 to other end of the conveyor system 100. In various examples, the at least one actuation media may correspond to at least one belt drive assembly. In some embodiments, each of the idler rollers 106 may comprise an axle (not shown). Further, the axle of each idler roller of the plurality of idler rollers 106 may be configured to facilitate coupling of each of the plurality of idler rollers 106 with each of the pair of side rails 104. In some embodiments, the pair of side rails 104 may be crafted with an elongated shape. In some embodiments, the pair of side rails 104 may be composed of a durable material. Further, the durable material may comprise at least one of a steel, iron, aluminum, etc. In some embodiments, the durable material of the pair of side rails 104 may be selected in a view of preventing any damage to the plurality of idler rollers 106 due to one or more environmental factors or a mechanical stress generated during operations of the conveyor system 100. Further, the one or more environmental factors may comprise at least one of a temperature, humidity, etc. In some embodiments, the pair of side rails 104 may be configured to assist the one or more objects 112 to move parallel over the conveyor system 100, via the plurality of idler rollers 106. In some embodiments, each of the pair of side rails 104 may be crafted with a plurality of mounting apertures 114. Further, the plurality of mounting apertures 114 may be configured to facilitate coupling of the axle of each of the plurality of idler rollers 106 with the pair of side rails 104.

In some embodiments, the side rail 108 of the pair of side rails 104 of the conveyor system 100 may be installed with the arm 102. In some embodiments, the arm 102 may be configured to pick and place the one or more objects 112 to and from the conveyor system 100. In some embodiments, the arm 102 may be constructed with a shape that may correspond to an inverted L-shape. In some embodiments, the arm 102 may be configured to rigidly mount with the side rail 108 of the pair of side rails 104 of the conveyor system 100 such that the arm 102 does not move relative to the side rail 108. In some embodiments, the arm 102 may be installed at an initial position 116 of the conveyor system 100. In some embodiments, the arm 102 may be coupled with the side rail 108 through a base structure 118. Further, the base structure 118 may facilitate coupling of the arm 102 with the side rail 108 of the pair of side rails 104 of the conveyor system 100. In some embodiments, the arm 102 may be configured to move along the side rail 108 of the conveyor system 100 from. Further, the arm 102 may be configured to move along the side rail 108 from the initial position 116 to one or more locations of the conveyor system 100.

In various examples, the base structure 118 may comprise a plurality of actuator wheels (not shown) when the arm 102 is configured to move along the side rail 108. Further, the plurality of actuator wheels may facilitate the arm 102 to move along the side rail 108 of the conveyor system 100 from the initial position 116 to the one or more locations of the conveyor system 100. In some embodiments, the base structure 118 may be composed of various materials. Further, the materials may include, but are not limited to, aluminum, stainless steel, etc. In some embodiments, the arm 102 may comprise a proximal portion 120 and a distal portion 122. Further, the proximal portion 120 of the arm 102 may be coupled with the base structure 118. In various examples, the distal portion 122 of the arm 102 may be coupled with the proximal portion 120 of the arm 102 at a 90-degree angle that may provide the inverted L-shape to the arm 102. In various examples, the arm 102 may be configured to linearly move along the side rail 108 of the conveyor system 100.

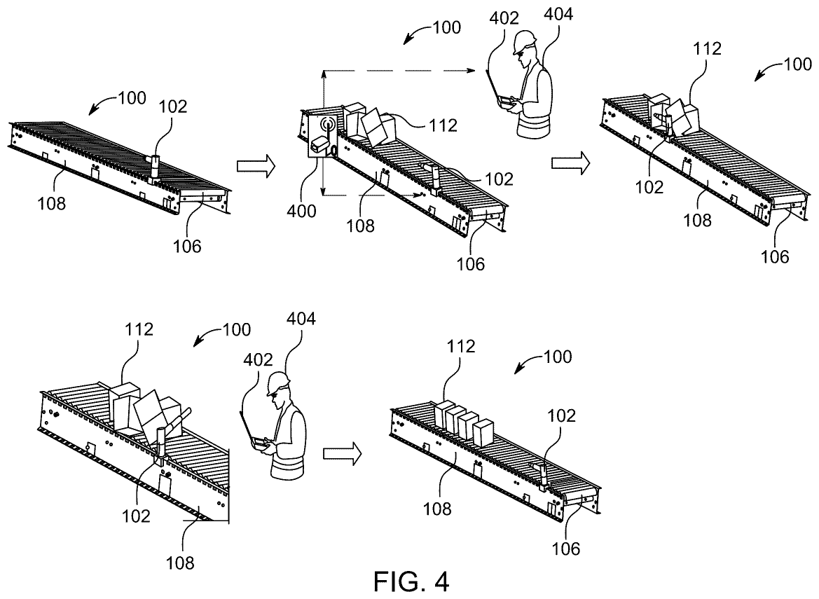

In some instances, while moving over the plurality of idler rollers 106 of the conveyor system 100, the one or more objects 112 may get jammed due to various reasons such as diversion of the conveyor system 100, software issues, hardware malfunctions, etc. In some embodiments, the conveyor system 100 may comprise a jam detector 400 (FIG. 4). Further, the jam detector 400 may be configured to detect a jam of the one or more objects 112 of the conveyor system 100. In some embodiments, the jam detector 400 may comprise one or more sensors (not shown). Further, the one or more sensors may include but not limited to an infrared (IR) sensor, ultrasonic sensor, distance sensor, etc. In various examples, the one or more sensors of the jam detector 400 may be equidistantly installed on an inner surface of the pair of side rails 104. In another example, the one or more sensors may be installed on each end of the pair of side rails 104.

Further, the one or more sensors of the jam detector 400 may be configured to monitor one or more parameters of the one or more objects 112 while moving over the conveyor system 100 to determine the jam of the one or more objects 112. Further, the one or more parameters may comprise speed of the one or more objects 112, position of the one or more objects 112, and/or any irregularities in movement of the one or more objects 112. In some embodiments, based at least on the monitored one or more parameters, the jam detector 400 may determine one or more anomalies such as a sudden halt in movement of the one or more objects 112, irregular spacing between the one or more objects 112, or piling-up of the one or more objects 112 at a specific point. Further, upon determining the one or more anomalies the jam detector 400 may generate a jam signal corresponding to the detection of the jam and send the jam signal to the arm 102.

In some embodiments, the arm 102 may be configured to receive the jam signal from the jam detector 400 of the conveyor system 100. In various examples, the arm 102 may comprise a control unit (not shown). Further, the control unit may include suitable logic, circuitry, and/or interfaces that are operable to execute one or more instructions stored in a memory (not shown) that may be coupled with the control unit to perform predetermined operations. In one embodiment, the control may be configured to decode the one or more instructions and execute the one or more instructions that are stored within the memory. The control unit may be configured to execute one or more computer-readable program instructions, such as program instructions to carry out any of the functions described in this description. In some embodiments, the control unit may be configured to receive the jam signal from the jam detector 400. In some embodiments, the jam signal may comprise location of the jammed one or more objects 112, and/or orientation of the one or more objects 112. In some embodiments, the control unit may be configured to provide one or more command signals to the arm 102 to unjam the one or more objects 112 on the conveyor system 100.

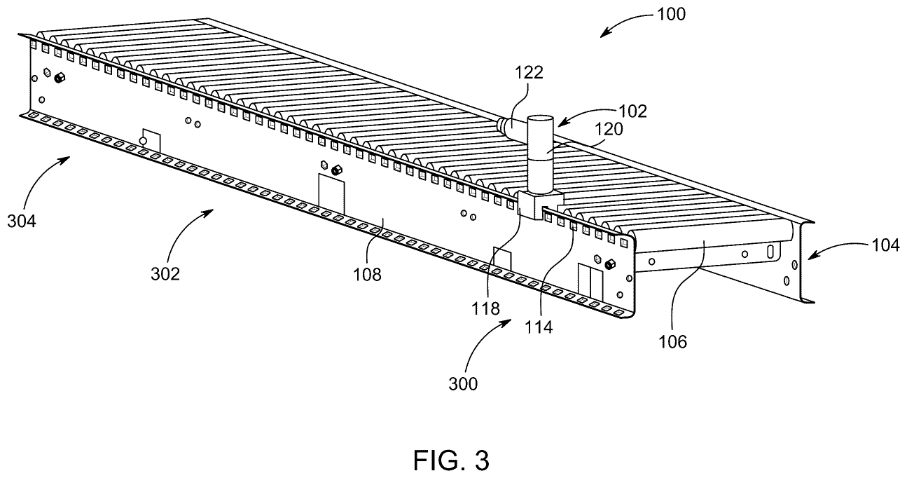

In some embodiments, upon receiving the one or more command signals, the arm 102 may be configured to move from along the side rail 108 of the conveyor system 100 from the initial position 116 to the location of the jammed one or more objects 112, via the base structure 118. Further, the arm 102 may comprise the proximal portion 120 and the distal portion 122. In some embodiments, the distal portion 122 of the arm 102 is movably relative to the proximal portion 120 of the arm 102. In some embodiments, the arm 102 may be configured to pick the one or more objects 112 from the one or more locations and place the one or more objects 112 to the another location through the end effector 110 to unjam the one or more objects 112. Further, the arm 102 may be configured to return back to its initial position 116 after placing the one or more objects 112 at the another location. In some embodiments, the initial position 116 may correspond to at least a start section position 300 (FIG. 3), an end section position 304 (FIG. 3), or a middle section position 302 (FIG. 3) of the conveyor system 100.

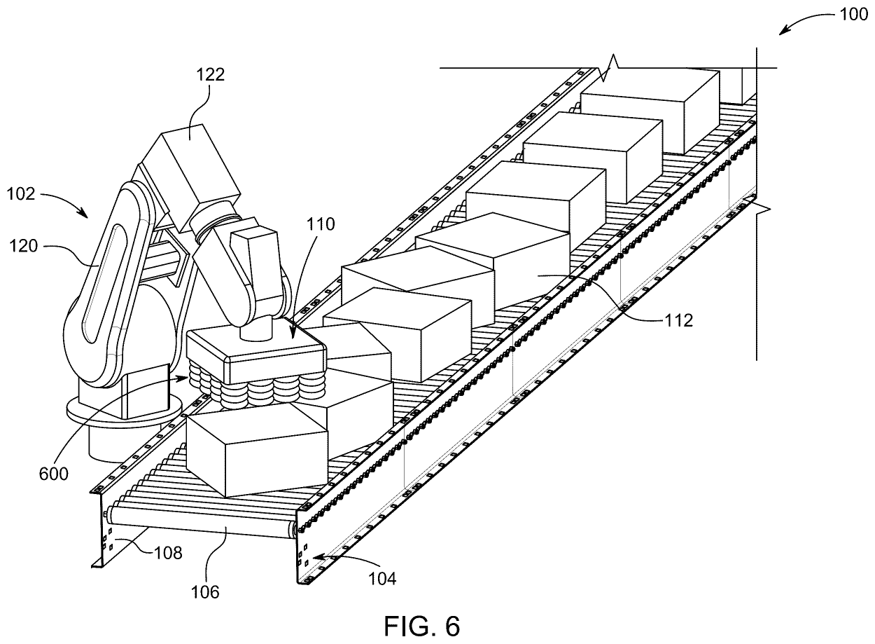

In some embodiments, the arm 102 may comprise the end effector 110. Further, the end effector 110 may be coupled with the distal portion 122 of the arm 102. In some embodiments, the end effector 110 may be configured to pick the jammed one or more objects 112 from the one or more locations and place the one or more objects 112 to another location to facilitate the arm 102 to unjam the one or more objects 112. Further, the end effector 110 may comprise at least one of a gripping arm or a vacuum suction grip unit 600 (FIG. 6). In various instances, when the end effector 110 may correspond to the gripping arm, then the gripping arm may comprise a plurality of mechanical fingers or clamps that may be configured to grasp and hold the one or more objects 112 firmly. Further, the gripping arm may be configured to adjust its strength and position to securely pick the one or more objects 112 based at least on the orientation of the one or more objects 112. In another instance, when the end effector 110 may correspond to the vacuum suction grip unit 600, then the vacuum suction grip unit 600 may comprise a suction mechanism that may utilize a negative pressure to lift and hold the one or more objects 112 to unjam the one or more objects 112.

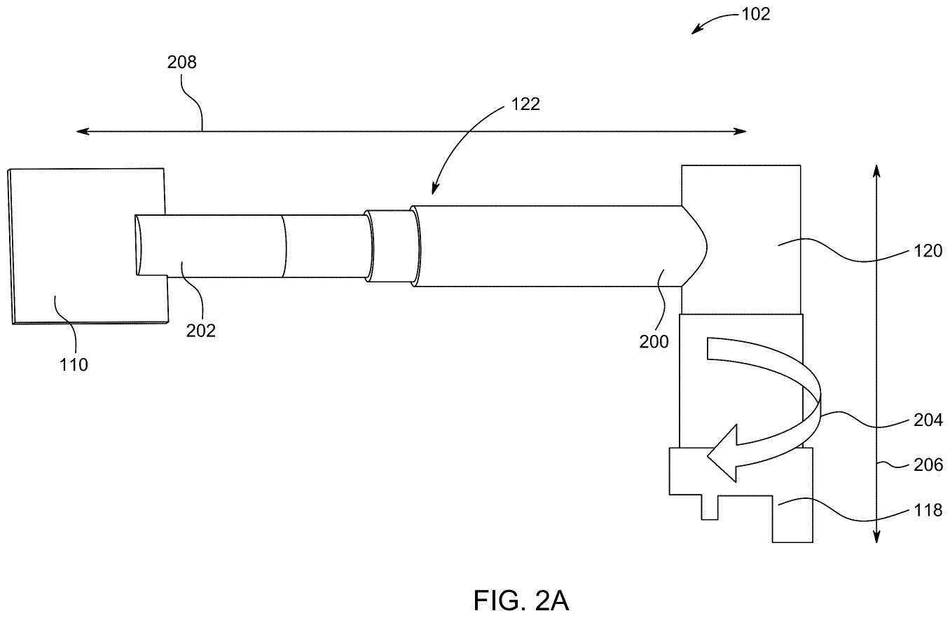

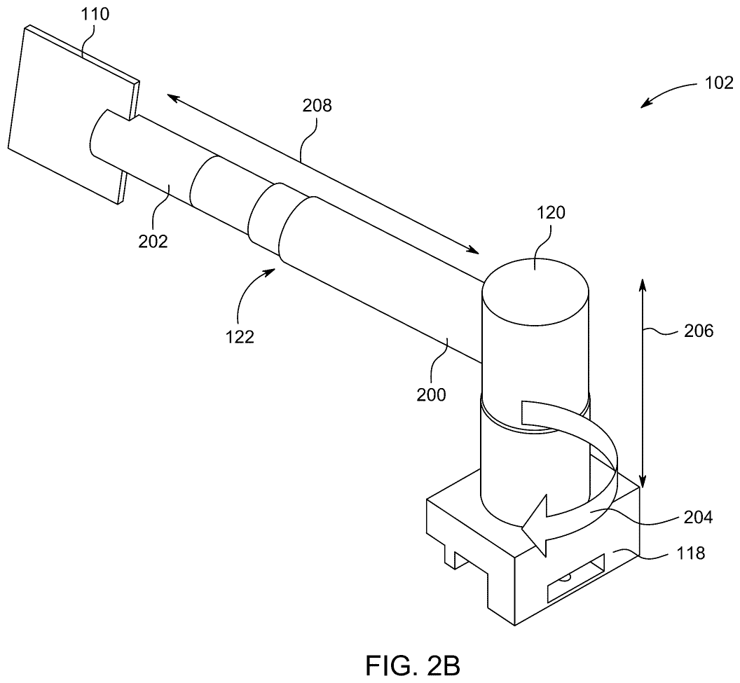

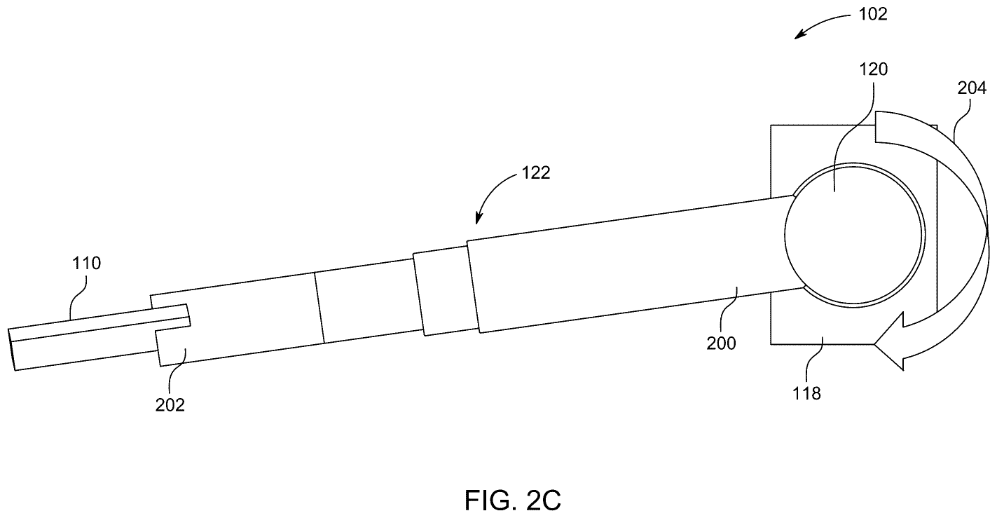

FIG. 2A illustrates a side view of the arm 102, in accordance with an example embodiment of the present disclosure. FIG. 2B illustrates an isometric view of the arm 102, in accordance with an example embodiment of the present disclosure. FIG. 2C illustrates a top view of the arm 102, in accordance with an example embodiment of the present disclosure.

In some embodiments, the arm 102 may comprise the proximal portion 120 and the distal portion 122. In some embodiments, the distal portion 122 of the arm 102 may define a first end 200 and a second end 202. In some embodiments, the first end 200 of the distal portion 122 of the arm 102 may be coupled to the proximal portion 120 in a right angle. In some embodiments, the first end 200 of the distal portion 122 of the arm 102 may be coupled to the proximal portion 120 through one or more processes. Further, the one or more process may include but not limited to a welding process, a casting process, a molding process, an additive manufacturing process (e.g., 3D printing process), or various machining processes. In some embodiments, the first end 200 of the distal portion 122 of the arm 102 may be coupled to the proximal portion 120 in the right angle such that the distal portion 122 of the arm 102 may configured to be positioned over the conveyor system 100. In some embodiments, the second end 202 of the distal portion 122 of the arm 102 may be coupled to the end effector 110 of the arm 102. In some embodiments, the proximal portion 120 and the distal portion 122 of the arm 102 may be constructed with a shape that may include but not limited to cylindrical shape, rectangular shape, etc.

Further, the distal portion 122 of the arm 102 may be moveable relative to the proximal portion 120 of the arm 102. In some embodiments, the proximal portion 120 of the arm 102 may define a rotational axis. In some embodiments, the proximal portion 120 of the arm 102 may be configured to rotate on the rotational axis, which is indicated by an arrow 204 that may facilitate the arm 102 to change positioning of the end effector 110 of the arm 102 while picking and placing the one or more objects 112. In some embodiments, the proximal portion 120 of the arm 102 may be configured to extend or retract in a vertical direction 206. In some embodiments, the distal portion 122 of the arm 102 may be configured to extend or retract in a horizontal direction 208. In some embodiments, the extension and retraction of the proximal portion 120 and the distal portion 122 of the arm 102 may facilitate proper positioning of the end effector 110 of the arm 102 on the one or more objects 112.

In various examples, the arm 102 may be coupled with one or more actuators (not shown). Further, the one or more actuators may comprise vertical telescopic actuators, horizontal telescopic actuators, and rotatory actuators. In some embodiments, the vertical telescopic actuators may be coupled with the proximal portion 120 of the arm 102. In some embodiments, the vertical telescopic actuators may facilitate the proximal portion 120 to extend in the vertical direction 206 and increase height of the arm 102. In some embodiments, the extension of the proximal portion 120 in the vertical direction 206 allows the end effector 110 of the arm 102 to be positioned above the jammed one or more objects 112. In some embodiments, the horizontal telescopic actuators may be coupled with the distal portion 122 of the arm 102. In some embodiments, the horizontal telescopic actuators may facilitate the distal portion 122 to extend in the horizontal direction 208 and increase reach of the arm 102. In some embodiments, the extension of the distal portion 122 in the horizontal direction 208 allows the end effector 110 of the arm 102 to be positioned close to the jammed one or more objects 112.

In some embodiments, the rotatory actuators of the arm 102 may be coupled with the proximal portion 120 of the arm 102. Further, the rotatory actuators may be configured to provide a rotational motion to the proximal portion 120 of the arm 102. In some embodiments, the rotatory actuators may facilitate the proximal portion 120 of the arm 102 to move on the rotational axis, which is indicated by the arrow 204. In some embodiments, the rotatory actuators may facilitate the arm 102 to change angle and orientation of the end effector 110. Further, the end effector 110 of the arm 102 may be configured to pick the one or more objects 112 from one location and place the one or more objects 112 to another location to unjam the one or more objects 112. In some embodiments, the one or more actuators may be communicatively coupled with the control unit. Further, the control unit may be configured to control extension and retraction of the one or more actuators, based at least on the jam signal received from the jam detector 400.

FIG. 3 illustrates an isometric view of the conveyor system 100 comprising the arm 102, in accordance with an example embodiment of the present disclosure. FIG. 4 illustrates operations of the arm 102 while unjamming the one or more objects 112 on the conveyor system 100, in accordance with an example embodiment of the present disclosure.

In some embodiments, the conveyor system 100 may comprise the plurality of idler rollers 106 and the pair of side rails 104. In some embodiments, the conveyor system 100 may be configured to translate the one or more objects 112 from one location to another location. In some embodiments, the conveyor system 100 may comprise a start section position 300, a middle section position 302, and an end section position 304. In various examples, the conveyor system 100 may be configured to translate the one or more objects 112 from the start section position 300 to the end section position 304 via the middle section position 302. In some embodiments, each idler roller of the plurality of idlers may be configured to rotate on its rotational axis to translate the one or more objects 112 from the start section position 300 to the end section position 304. In some embodiments, the pair of side rails 104 may be coupled with the plurality of idler rollers 106. Further, the pair of side rails 104 may be configured to direct the one or more objects 112 while moving over the conveyor system 100.

As illustrated in FIG. 3, the arm 102 may be coupled with the side rail 108 of the pair of side rails 104 of the conveyor system 100. In some embodiments, the arm 102 may be configured to be movably coupled to the side rail 108 of the conveyor system 100. In some embodiments, the arm 102 may be coupled with the side rail 108 of the conveyor system 100 through the base structure 118. Further, the base structure 118 may comprise the plurality of actuator wheels that may provide movement to the arm 102 over the side rail 108 of the conveyor system 100. In some embodiments, the arm 102 may be configured to move orthogonally along the side rail 108 of the conveyor system 100. In some embodiments, the conveyor system 100 may comprise the jam detector 400. Further, the jam detector 400 may be configured to detect the jam of the one or more objects 112 over the conveyor system 100. In some embodiments, the jam detector 400 may be configured to generate the jam signal. In some embodiments, the jam detector 400 may be communicatively coupled with the arm 102. Further, the jam detector 400 may be configured to send the jam signal to the arm 102.

As illustrated in FIG. 4, the jam detector 400 may be communicatively coupled to a user device 402. In some embodiments, the user device 402 may include but not limited to a display device, a laptop, a mobile terminal, etc. In some embodiments, upon generating the jam signal, the jam detector 400 may concurrently send the jam signal to the user device 402. In some embodiments, the user device 402 may be operated by a user to monitor operations of the conveyor system 100. In various examples, the jam detector 400 may also be communicatively coupled to the user device 402 and various other n-number of user devices. In some embodiments, the user device 402 may enable the user to provide various commands related to operations of the arm 102.

In some embodiments, the arm 102 may be configured to receive the jam signal. In some embodiments, the arm 102 may comprise the proximal portion 120, the distal portion 122, the end effector 110, and the one or more actuators. In some embodiments, upon receiving the jam signal, the control unit of the arm 102 may direct the plurality of actuator wheels to move the arm 102 towards the jammed one or more objects 112. In various examples, the conveyor system 100 may comprise a plurality of fenced structures (not shown). Further, each of the plurality of fenced structure may be coupled with the pair of side rails 104. Further, each of the plurality of fenced structure may be configured to barricade the arm 102 while moving over the side rail 108. The fenced structure may increase the safety of the conveyor system 100 and prevent injuries to an operator 404. For example, the fenced structure may prevent access to the conveyor system 100 by the operator 404, which may avoid the operator 404 coming in contact with moving components of the arm 102.

In some embodiments, upon positioning of the arm 102, the control unit of the arm 102 may direct the vertical telescopic actuators to provide extension or retraction to the proximal portion 120 of the arm 102 in the vertical direction 206. Further, the extension or retraction of the proximal portion 120 of the arm 102 may facilitate positioning of the end effector 110 above the one or more objects 112. In some embodiments, the control unit of the arm 102 may direct the horizontal telescopic actuators to provide extension or retraction to the distal portion 122 of the arm 102 in the horizontal direction 208. Further, the extension or retraction of the distal portion 122 of the arm 102 may facilitate positioning of the end effector 110 close to or away from the one or more objects 112. In some embodiments, the control unit of the arm 102 may direct the rotatory actuators to provide the rotational motion to the arm 102. Further, the rotational motion of the arm 102 may adjust angle and positioning of the end effector 110. Further, the end effector 110 of the arm 102 may be configured to pick the one or more objects 112 to unjam the one or more objects 112 on the conveyor system 100.

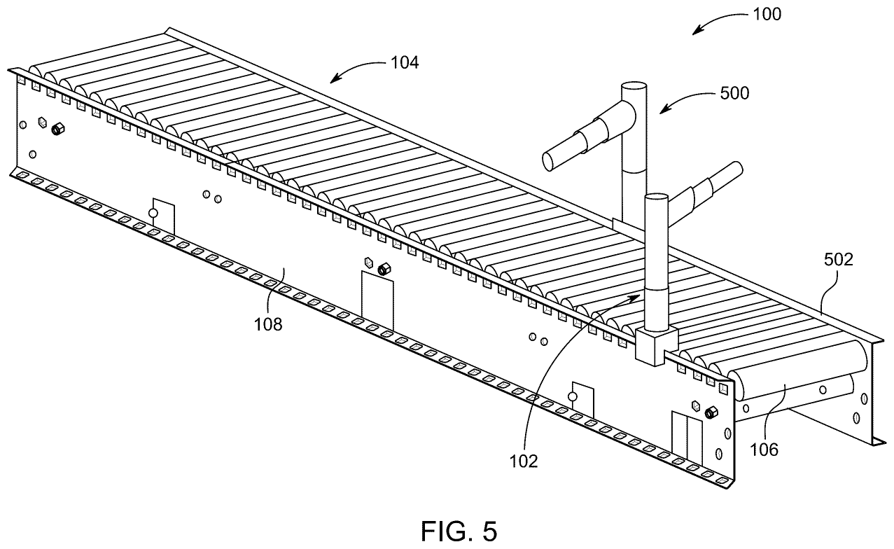

FIG. 5 illustrates an isometric view of the conveyor system 100 comprising a plurality of arms, such as the arm 102 and another arm 500, in accordance with another example embodiment of the present disclosure. FIG. 6 illustrates an isometric view of the conveyor system 100 comprising the arm 102 having the end effector 110, in accordance with an example embodiment of the present disclosure.

In some embodiments, the arm 102 may be coupled with the side rail 108 of the pair of side rails 104 of the conveyor system 100. In some embodiments, the another arm 500 may be coupled with another side rail 502 of the pair of side rails 104 of the conveyor system 100. In some embodiments, the another arm 500 may be coupled to the same rail of the pair of side rails 104 of the conveyor system 100 as the arm 102. In some embodiments, the arm 102 and the another arm 500 may be configured to be rigidly coupled to the pair of side rails 104 of the conveyor system 100, such that they are not configured to move relative to the side rails 104.

In some embodiments, the arm 102 may be configured to be movably coupled to the side rail 108 of the conveyor system 100. In some embodiments, the another arm 500 may be configured to be movably coupled to the another side rail 502 of the conveyor system 100. In some embodiments, the arm 102 and the another arm 500 may be configured to move parallel along the side rail 108 and the another side rail 502 of the conveyor system 100. In some embodiments, the conveyor system 100 may comprise the jam detector 400. Further, the jam detector 400 may be configured to detect the jam of the one or more objects 112 over the conveyor system 100. In some embodiments, the jam detector 400 may be configured to generate the jam signal. In some embodiments, the jam detector 400 may be communicatively coupled with the arm 102 and the another arm 500. Further, the jam detector 400 may be configured to send the jam signal to the arm 102 and the another arm 500.

In some embodiments, the arm 102 and the another arm 500 may be configured to receive the jam signal. In some embodiments, each of the arm 102 and the another may comprise the proximal portion 120, the distal portion 122, the end effector 110, and the one or more actuators. In some embodiments, upon receiving the jam signal, the control unit of the arm 102 and/or the another arm 500 may direct the vertical telescopic actuators to provide extension or retraction to the proximal portion 120 of at least one of the arm 102 or the another arm 500 in the vertical direction 206. Further, the extension or retraction of the proximal portion 120 of each of the arm 102 or the another arm 500 may facilitate positioning of the end effector 110 of at least one of the arm 102 or the another arm 500 above the one or more objects 112. In some embodiments, the control unit of at least one of the arm 102 or the another arm 500 may direct the horizontal telescopic actuators to provide extension or retraction to the distal portion 122 of at least one of the arm 102 or the another arm 500 in the horizontal direction 208. Further, the extension or retraction of the distal portion 122 of at least one of the arm 102 or the another arm 500 may facilitate positioning of the end effector 110 of at least one of the arm 102 or the another arm 500 close to or away from the one or more objects 112. In some embodiments, the control unit of the arm 102 and/or the another arm 500 may direct the rotatory actuators to provide the rotational motion to the arm 102 and/or the another arm 500. Further, the rotational motion of at least one of the arm 102 or the another arm 500 may adjust the angle and positioning of the end effector 110 of the arm 102 and/or the another arm 500. Further, the end effector 110 of the arm 102 and/or the another arm 500 may be configured to pick the one or more objects 112 to unjam the one or more objects 112 on the conveyor system 100.

As illustrated in FIG. 6, the end effector 110 of the arm 102 may correspond to the vacuum suction grip unit 600. In some embodiments, the arm 102 may be configured to position the end effector 102 above the one or more objects 112 over the conveyor system 100. Further, upon positioning the end effector 110, the vacuum suction grip unit 600 of the arm 102 may be configured to generate the negative pressure to grip the one or more objects 112. In various examples, the vacuum suction grip unit 600 may comprise the suction mechanism that is configured to generate the negative pressure. Further, the arm 102 may be configured to move the end effector 110 along with the vacuum suction grip unit 600 at various angles and positions to unjam the one or more objects 112 on the conveyor system 100.

In some embodiments, a method to unjam the one or more objects 112 on the conveyor system 100 is disclosed. The method may comprise one or more operations. At one operation, the arm 102 configured to be coupled to the side rail 108 of the conveyor system 100 may be configured to receive the jam signal from the jam detector 400 of the conveyor system 100. Further, the end effector 110 may be configured to pick and place the one or more objects 112 to or from the conveyor system 100. Further, the jam detector 400 may be configured to detect the jam of the one or more objects 112 on the conveyor system 100 and generate the jam signal corresponding to the detection of the jam. At another operation, the arm 102 may be configured to pick the one or more objects 112 to unjam the one or more objects 112 on the conveyor system 100 in response to receiving the jam signal from the jam detector 400.

The present disclosure streamlines clearing of the jammed one or more objects 112 on the conveyor system 100. Embodiments of the present invention may precisely determine portion of the conveyor system 100 comprising the jammed one or more objects 112 through the jam detector 400. Embodiments of the present invention may clear the jammed one or more objects 112 from the conveyor system 100 through the arm 102. Embodiments of the present invention may be configured to pick and place the one or more objects 112 to unjam the one or more objects 112 on the conveyor system 100. Embodiments of the present invention may be configured to provide barricading around the arm 102 to address safety concerns around the conveyor system 100.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An arm configured to be coupled to a side rail of a conveyor system, the arm comprising:
an end effector configured to pick and place one or more objects to or from the conveyor system, wherein the arm is configured to:
receive a jam signal from a jam detector of the conveyor system, wherein the jam detector is configured to detect a jam of the one or more objects on the conveyor system and generate the jam signal corresponding to the detection of the jam; and
pick the one or more objects to unjam the one or more objects on the conveyor system in response to receiving the jam signal from the jam detector.

2. The arm of claim 1, wherein the arm comprises a proximal portion and a distal portion, wherein the distal portion is moveable relative to the proximal portion.

3. The arm of claim 2, wherein the proximal portion defines a rotational axis, and wherein the proximal portion is configured to rotate on the rotational axis.

4. The arm of claim 2, wherein the proximal portion is configured to extend or retract along a vertical direction and the distal portion is configured to extend or retract along a horizontal direction.

5. The arm of claim 2, wherein the distal portion defines a first end and a second end, and wherein the first end of the distal portion is coupled to the proximal portion in a right angle such that the distal portion is configured to be positioned over the conveyor system.

6. The arm of claim 5, wherein the end effector is coupled to the second end of the distal portion for picking and placing the one or more objects on the conveyor system.

7. The arm of claim 1, wherein the arm is moveably coupled to the side rail of the conveyor system, and wherein the arm is configured to move along the side rail from an initial position to one or more locations to pick the one or more objects from the one or more locations and place the one or more objects to another location.

8. The arm of claim 7, wherein the arm is configured to return back to the initial position after placing the one or more objects at the another location.

9. The arm of claim 7, wherein the initial position corresponds to at least a start section position, an end section position, or a middle section position of the conveyor system.

10. The arm of claim 1, wherein the arm is rigidly coupled to the side rail of the conveyor system.

11. The arm of claim 1, wherein the end effector comprises a gripping arm or a vacuum suction grip unit.

12. A method comprising:
receiving, via an arm configured to be coupled to a side rail of a conveyor system, a jam signal from a jam detector of the conveyor system, a jam signal from a jam detector of the conveyor system, wherein the jam detector is configured to detect a jam of one or more objects on the conveyor system and generate the jam signal corresponding to the detection of the jam; and
picking, via the arm, the one or more objects to unjam the one or more objects on the conveyor system in response to receiving the jam signal from the jam detector, wherein the arm comprises an end effector configured to pick and place the one or more objects to or from the conveyor system.

13. The method of claim 12, wherein the arm comprises a proximal portion and a distal portion, wherein the distal portion is moveable relative to the proximal portion, and wherein the arm is rigidly coupled to the side rail of the conveyor system.

14. The method of claim 13, wherein the proximal portion defines a rotational axis, and wherein the proximal portion is configured to rotate on the rotational axis.

15. The method of claim 13, further comprising extending or retracting the proximal portion along a vertical direction and the distal portion along a horizontal direction.

16. The method of claim 13, wherein the distal portion defines a first end and a second end, and wherein the first end of the distal portion is coupled to the proximal portion in a right angle such that the distal portion is configured to be positioned over the conveyor system.

17. The method of claim 16, wherein the end effector is coupled to the second end of the distal portion for picking and placing the one or more objects on the conveyor system.

18. The method of claim 12, wherein the arm is moveably coupled to the side rail of the conveyor system, and wherein the arm is configured to move along the side rail from an initial position to one or more locations to pick the one or more objects from the one or more locations and place the one or more objects to another location.

19. The method of claim 18 further comprising returning the arm back to the initial position after placing the one or more objects at the another location, wherein the initial position corresponds to at least a start section position, an end section position, or a middle section position of the conveyor system.

20. The method of claim 12, wherein the end effector comprises a gripping arm, or a vacuum suction grip unit.
